(19) United States
(12) Patent Application Publication
(10) Pub. No.: US 2004/0250158 A1
(43) Pub. Date: Dec. 9, 2004

(54) System and method for protecting an IP transmission network against the denial of service attacks

(76) Inventors: Jean-Francois Le Pennec, Nice (FR); Aurelien Bruno, Nice (FR); Claude Galand, La Colle sur Loup (FR); Jean-Marie Sommerlatt, Vence (FR)

Correspondence Address: AT&T CORP., P.O. BOX 4110, MIDDLETOWN, NJ, 07748, US

(21) Appl. No.: 10/638,862

(22) Filed: Aug. 11, 2003

(30) Foreign Application Priority Data
Mar. 20, 2003 (FR) 0303414

(51) Int. Cl. H02H 3/05

(52) U.S. Cl. 714/4

(57) ABSTRACT

Data transmission system including at least a data transmission network (10, 12), at least a server (29), a plurality of users (16, 18, 20) able to be connected to the server in order to get data from it and at least a user being able to initiate a denial of service attack, the system further including a security network manager (30) and at least a detecting device for detecting abnormal operating conditions with respect to an operation of the system defined by predetermined parameters and transmitting detection messages to the security network manager, the security network manager activating filtering actions upon receiving the detection messages.

### TECHNICAL FIELD

The present invention relates generally to the networking environment wherein a key issue is denial of service attacks and relates particularly to a system and a method for protecting an IP transmission network against the denial of service attacks.

### BACKGROUND

Among the attacks against the networking environment wherein a plurality of users can access to a plurality of servers, the denial of service (DoS) is becoming more and more detrimental for the IP networks.

A DoS attack is characterized by explicit attempts by attackers to prevent legitimate users of a service from using this service. Such attempts include the attempt to flood a network thereby preventing the legitimate network traffic to be made correctly, the attempt to disrupt connections between two machines thereby preventing access to a service, the attempt to prevent a particular user from accessing a service and the attempt to disrupt a service to a specific system or person.

Denial of service attacks can be classified by the result of the attack which can be consumption of scarce, limited or non-renewable resources, destruction or alteration of some configuration information or physical destruction or alteration of network components. They can also be classified by the method being used. The two main methods are the “magic packet” attacks and the resource-exhaustion attacks. Magic packet attacks usually exploit a vulnerability in the operating system or the application by sending one or a few particular packets and typically result in a highly abnormal response, excessive CPU utilization or a full system crash. The infamous “Ping of Death” and “WinNuke” attacks belong to this category.

Resource-exhaustion attacks do not rely on the vulnerability, but take advantage of a basic fact which is that computing resources are finite. The server has only so much RAM, can handle only so many clients at a time, and can process only so many bytes per second through the attached networks. A resource-exhaustion DoS is when an attacker knowingly attempts to take up as many resources as possible, robbing other users.

DoS attacks are easy to perpetrate and almost impossible to defend against. The fault lies in the structure of the Internet and its protocols. Internet was designed from the outset to be robust and to get the messages through, no matter what. There are specific defences against these attacks. Specifically, it is necessary to keep software up-to-date, to install vendor patches where it is possible, and to restrict access to services as much as possible. Physical security is also important. Filtering and scanning content is a must. This can be as simple as a packet-level firewall, or as complex as the use of virus scanning proxy servers and intrusion detection systems.

But such current methods that implement heavy filtering have some drawbacks because they kill performance insofar as the filtering processing is permanently activated and costs a lot since all the traffic has to be filtered.

Specific devices, such as Intrusion Detection Systems (IDS), have been designed to detect different known types of intrusions. An IDS is a system for detecting intrusions from hackers, not only for DoS but for all types of intrusions. An IDS monitors packets on the network on which it is plugged and attempts to discover if a hacker/cracker is attempting to break into a system or to run a denial of service attack. A typical example is a system that watches for a large number of TCP connection requests to many different ports on a target machine, thus discovering if someone is attempting a TCP port scan. An IDS may run either on the target machine which watches its own traffic, such as a firewall, or on an independent machine watching all network traffic (hub, router, probe).

DoS attacks are techniques which do not require sniffing but just spoofing to be less visible even to IDS and more difficult to remove. Thus, DoS attacks that rely on modified packets of connectionless protocols can use IP spoofing in order to masquerade the true origin of the packets. This means that, even if it is possible to detect the attack, it is not possible to trace or to stop it since the attacker does not need any response from the target.

In order to detect and stop attacks, many companies now implement Intrusion Detection Systems (IDS). However, a problem with IDS systems is that they have to do a wide range of CPU intensive and stateful protocol analysis. The packets can be built to use a maximum amount of IDS resources per packet. By using a large amount of spoofed IP addresses, and by using these to create as many as possible state objects on the IDS system, it will be possible by doing the maximum of protocol analysis, in many cases, to heighten the latency of the IDS detection to such an extent that the full attack can be implemented before the IDS has been able to detect it.

In many cases, IDS and firewall systems will be able to early detect attacks, especially known attacks. A firewall may take action on this by blocking the specific suspect IP address for a period of time. However, the problem of IP address spoofing is such that few administrators choose to implement this solution.

If a firewall blocks any IP packet that initiates an attack, an attacker who would spoof a large range of IP addresses will be able to let the firewall become a DoS tool because, finally, the firewall will slow down all the traffic. In fact, this means that there is a difficult choice for the network between being potentially penetrable or being highly DoS sensible when more complex filtering is implemented to fight against spoofed addresses.

In addition, it is well-known that most service providers and manufacturers do not take today enough anti-spoofing measures because such measures bring performance drawbacks. The result is that there is a large underestimation of the spoofing risk, both with system administrators and with device manufacturers.

A solution to the DoS problem could be to implement a mechanism to detect on an ingress node at the network boundary the occurrence of repetitive actions and then to crosscheck with another ingress node if the same action is detected. But this solution has the drawback to permanently analyze a lot of traffic at the boundary and to provide a protection of the network routers and not of only defined servers, whereas the DoS attacks are done generally against servers. To implement such a solution would require new resources in order to analyze all the traffic more important than what is necessary to just transport the traffic, resulting in a performance impact due to the permanent analysis and an increased cost and complexity of the network due to the additional equipment or features not really affordable.

### SUMMARY OF THE INVENTION

The object of the invention is accordingly to provide a mechanism in a network system which detects in the traffic from a plurality of sources a denial of service attack and takes appropriate actions to remove the attack without stopping the normal use of the network and without impacting the network performance in normal conditions.

The invention relates therefore to a data transmission system including at least a data transmission network, at least a server, a plurality of users able to be connected to the server in order to get data from it and at least a user being able to initiate a denial of service attack. The system further includes a security network manager and at least a detecting device for detecting abnormal operating conditions with respect to an operation of the system defined by predetermined parameters and for transmitting detection messages to the security network manager, the security network manager activating filtering actions upon receiving the detection messages.

According to another aspect, the invention relates to a method for protecting a data transmission system against a denial of service attack, including the steps of detecting by detecting devices abnormal operating conditions of the data transmission system, transmitting to a security network manager a detection message from a detecting device having detected abnormal operating conditions, analyzing the received detection message for determining whether there is a DoS attack and from which source this attack comes, and activating actions by the security network manager, such actions being applied to one or a plurality of devices of the system which are on the path between the source of the attack and the attacked device.

### BRIEF DESCRIPTION OF THE DRAWINGS

The above and other objects, features and advantages of the invention will be better understood by reading the following more particular description of the invention in conjunction with the accompanying drawings wherein:

FIG. 1 is a block diagram representing a first embodiment of a data transmission system implementing the invention;

FIG. 2 is a block diagram representing a second embodiment of a data transmission system implementing the invention;

FIG. 3 is a diagram representing the various detection messages and actions which are exchanged between the detecting devices and the security network manager; and

FIG. 4 is a flow chart of the steps achieved in the security network manager upon reception of a detection message from a detecting device.

### DETAILED DESCRIPTION OF THE INVENTION

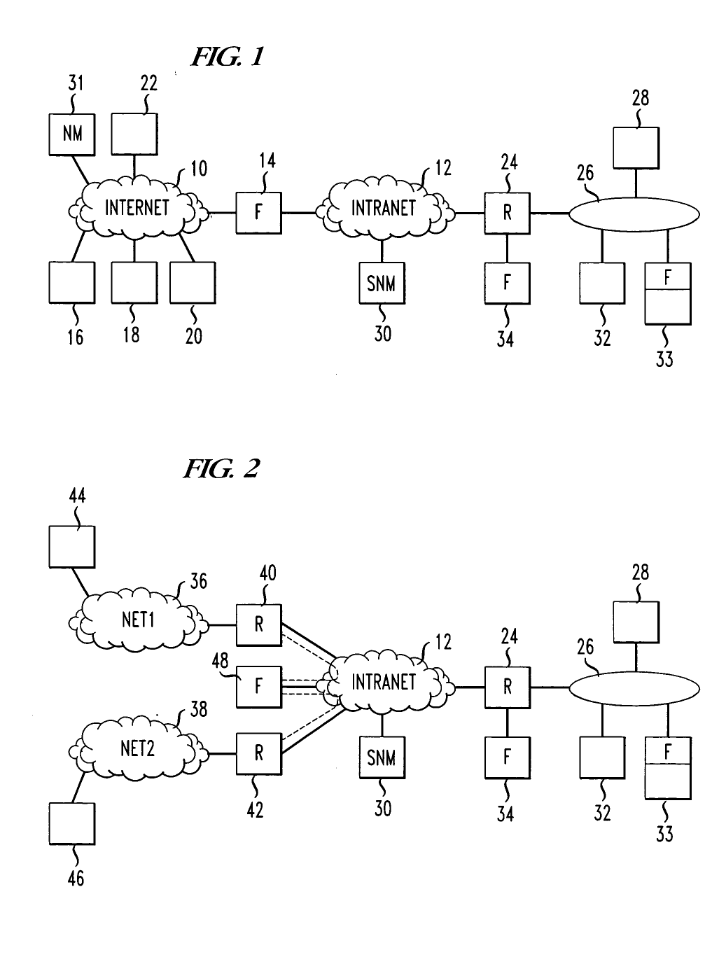

According to a preferred embodiment described in reference to FIG. 1, a data transmission system wherein the invention can be implemented includes a public data transmission network such as Internet 10 and an Intranet network 12 linked together by means of a firewall 14. A plurality of users 16, 18, 20 are connected to network 10 and also a device 22 launching a DoS attack to the system. The Intranet network 12 is linked by means of a router 24 to a LAN 26 to which is connected a server 28 which can be requested by users 16, 18 and 20 in order for these users to get information.

Assuming that the mechanism according to the invention is not used, the first way of stopping a DoS attack from attacker 22 is simply, when the attack is detected, to drop all traffic related to the server 28 in firewall 14. This one can be equipped for filtering non-essential protocols like Internet Control Message Protocol (ICMP), but dropping Transmission Control Protocol (TCP) or User Datagram Protocol (UDP) can impact or even stop the legitimate traffic.

If an attack is originating from one or a small number of true hosts, as opposed to being randomly spoofed, a device that tracks source IP addresses will be able to home in on the specific offenders and drop all traffic from those hosts. However, tracking every unique source IP address is quite a processing feat, requiring large amounts of memory. Therefore, a solution is to divide the Internet into smaller, more manageable areas. While this way lets the devices track the general origin of an attack, blocking areas of the Internet—particularly if they are big areas like cable-modem segments or America Online user proxies—hurts legitimate traffic. However, this can still be an effective form of attack mitigation. More and more, DoS packets are spoofing source addresses and, therefore, packets are not coming from the IP address indicated in the packet. If, in addition, the value is randomly set, there is no way to filter based on the source IP address.

The next known mitigation method is the floodgate approach. This means that the device drops most traffic but occasionally lets small amounts of traffic pass for a short period. That traffic is likely to consist of both legitimate and attack traffic. In this situation, the packet flow is reduced to smaller bursts, preventing the target system from being overloaded while also attempting to accommodate some legitimate traffic.

A last known, recently developed, mitigation tactic exists which consists of traffic analysis with selective filtering. In this case, the device actually determines traffic characteristics to come up with a common feature to distinguish (and thus filter) attack traffic. Of course, this is easier said than done and depends on some feature being common and unique to attack traffic. Examples would be a static TTL (time to live), sequence number, source port or IP ID. Fortunately, many publicly available DoS attack tools do produce such a phenomenon, so this approach does seem to be effective for the time being. This type of feature is implemented in specific devices like improved firewalls, which are complex and costly, but is not available in routers. This means that the main filtering capabilities are located at the boundary of the network and not within the intranet network. Capabilities to fight DoS attacks within the intranet or within the LAN 26 where servers are connected are very difficult. Few rules may be implemented in internal routers such as router 24.

According to the invention, a security network manager (SNM) 30 is connected to Intranet 12 and is adapted to identify the causes of malfunction that may be due to a possible DoS attack and define appropriate actions. The SNM permanently receives information from detecting devices which are the firewalls like firewall 14, the routers (or switches) like router 24, the servers like server 28 and even workstations.

As detecting devices, it may be appropriate to use specific probes like probe 32 configured to provide a detailed analysis of server 28 traffic. In this case, probe 32 is configured to analyze all packets from server 28 but can act as a proxy device to gather events from server 28. Such a probe connected to LAN 26 can be a remote network monitoring probe which is a wiretap device that plugs into computer networks and eavesdrops on the network traffic. It allows traffic analysis for the attached network segment. It can provide bandwidth utilization, top talkers, pair statistics, network critical activity. It can also capture packets and analyze protocols and sub-protocols (all or selected), Web server and router observer function or focus on specific devices for deep analysis. Such a probe can also be used to discover MAC addresses and aliases for IP addresses and DNS name resolution. Therefore, it is also a mean for detecting ARP (Address Resolution Protocol) and DNS (Domain Name Server) spoofing. Such a probe is just a passive device that does not alter packets. The only action is to inform other devices such as the Security Network Manager SNM device that something has been detected.

The advantage of the SNM 30 with respect to a single IDS is that it correlates events and alarms from several devices such as security probes, firewalls, routers, switches and servers for security purposes. The global understanding of the attack allows defining the most appropriate rules in each filtering device in answer to the attack without affecting the normal traffic. In such an environment, for example, SNM will define rules for router 24 and firewall 14.

A rule for router 24 could be to re-route all the traffic for the server 28 to a firewall 34 connected to router 24. As complex rules can be applied in a firewall but not in a router, it is affectively more efficient to re-route the traffic from the router to a firewall for the doubtful traffic than to apply more sophisticated rules in the router itself. The filtered traffic from firewall 34 can then reach server 28. Similar rules may be applied in firewall 14 to fight the attacks from network 10. Implementing a firwall at each boundary point is the current alternate method that has the drawback of performance impact and cost and does not provide correlated actions.

When a potential attack is detected in view of a number of similar accesses to server 28 being logged by the server itself or by security probe 32, the source addresses are identified or, if possible, the path from the network ingress node. If a source address is spoofed, SNM 30 asks each boundary device such as firewall 14 to identify incoming packets having common characteristics and whose destination is the attacked server. Then, rules are applied to all corresponding boundary devices on which attacks are detected by SNM 30. Devices that do not forward DoS traffic do not need to be modified in such model, resulting in selective counter measures.

It is also possible that a server connected to LAN 26 includes its own firewall, such as server 33. In such a case, a recommended solution is to store and maintain the configuration of the associated firewall within security probe 32 in order to avoid server 33 from being penetrated when the firewall configuration is updated. In such an implementation, the firewall configuration within the security probe is updated by the security network manager when necessary. Regularly, the firewall within server 33 polls the security probe 32 to determine whether its configuration has been modified.

On local probes, such as probe 32, only security scanning is performed, most of the security activity being done on SNM 30. The advantage is to perform filtering on ingress devices only when a DoS is detected on devices within the network so that it has no performance impact. Filtering is also performed within the intranet in routers such as router 24 and firewalls such as firewall 34 in order not to propagate the attack within the intranet if the DoS keeps control of internal devices such as servers or workstations.

Note that a network management (NM) platform 31 connected to Internet network 10 is used as a legacy infrastructure of external network providers from which the attacks are coming. Messages are transmitted from SNM 30 to NM 31 each time a potential attack has been detected.

If a device within a network is identified as being heavily loaded, which may correspond to the beginning of a DoS or a distributed DoS (DDOS) attack, then rules are applied only on ingress devices from which DoS traffic is detected by probes. This allows taking measures before the effective peak of DoS attack and overload of the server or network device. The fact that strong filtering measures are taken after the detection of a DoS attack does not prevent implementation of basic security rules at the boundary on firewalls such as firewall 14. One advantage of such a distributed mechanism is that it will react from unknown DoS attacks as well.

On top of ingress device filtering and internal filtering, DoS information is provided by the SNM to neighbor networks to take appropriate actions. For example, SNM 30 will inform the network management platform of the Internet network NM 31 when a DoS attack is detected coming from the Internet, thus allowing propagation of counter measures through different providers.

Servers such as server 28 can receive recommendations and rules to apply from SNM 30 to improve their protections as well and, on the reverse side, may send alerts to the security probe 32 or SNM 30 based on local alarms and security logs.

FIG. 2 illustrates an embodiment wherein Intranet 12 is connected to other private networks such as NET1 36 and NET2 38 by means of routers 40 and 42, respectively. No permanent firewall is implemented to protect this interconnection which is normally considered less risky than the Internet. In a large distributed DDoS attack, some hosts like host 44 and host 46 may become hacking stations. Complex DoS attacks may not be correctly filtered by routers 40 and 42 even if they are correctly detected by security probes like probe 32 or a server being attacked like sever 28.

As it has been done in FIG. 1, the process is to reconfigure dynamically routers 40 and 42 to establish tunnels which are point-to-point logical links with a firewall like firewall 48 which can be shared by several routers. The routers will reroute the traffic which is potentially a DoS traffic to the shared firewall which will take filtering measures. This firewall can have a direct connection on the Intranet to forward the filtered traffic in order to avoid going back to the original router.

In addition it is also possible to establish a tunnel between firewall 34 and firewall 48 for the traffic related to server 28 in order to isolate this traffic.

Depending on the importance of the server and its corresponding traffic, it is also possible to reclassify a part or all of the traffic going to and coming from server 28, for example to use a lower CoS (Class of Service) in order not to impact the remaining network traffic even if this server is heavily loaded. A random discard which is one of the appropriate measures is applied to such a low class in case of congestion.

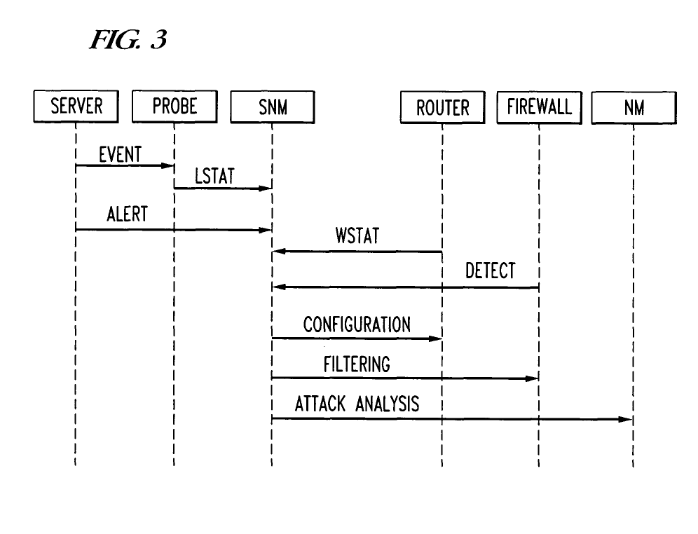

In reference to FIG. 3, the detecting devices regularly and/or in case of major event update the SNM 30. For example, probe 32 updates SNM 30 via messages “LStat” providing LAN statistics. If probe 32 is configured to provide detailed analysis of server 28, it analyzes all packets from and to server 28 but can also act as a proxy device to gather events from server 28. But alerts raised by server 28 have to be directly forwarded to SNM 30 in order to save time as generally probes are polled by SNM.

As already mentioned, routers, firewalls and switches (not shown) are also detecting devices and can provide SNM with WAN statistics “WStat” or detection of intrusions using “Detect” messages. The SNM analyzes the events, calculates the risk, identifies the type of attack and where it comes from and then defines the new configuration for each protecting or reacting device. External flows include configuration messages to the routers and switches and filtering configuration messages for firewalls. In addition, the SNM can propagate its attack analysis to a neighbor network management system like NM 31 in order for it to take additional actions.

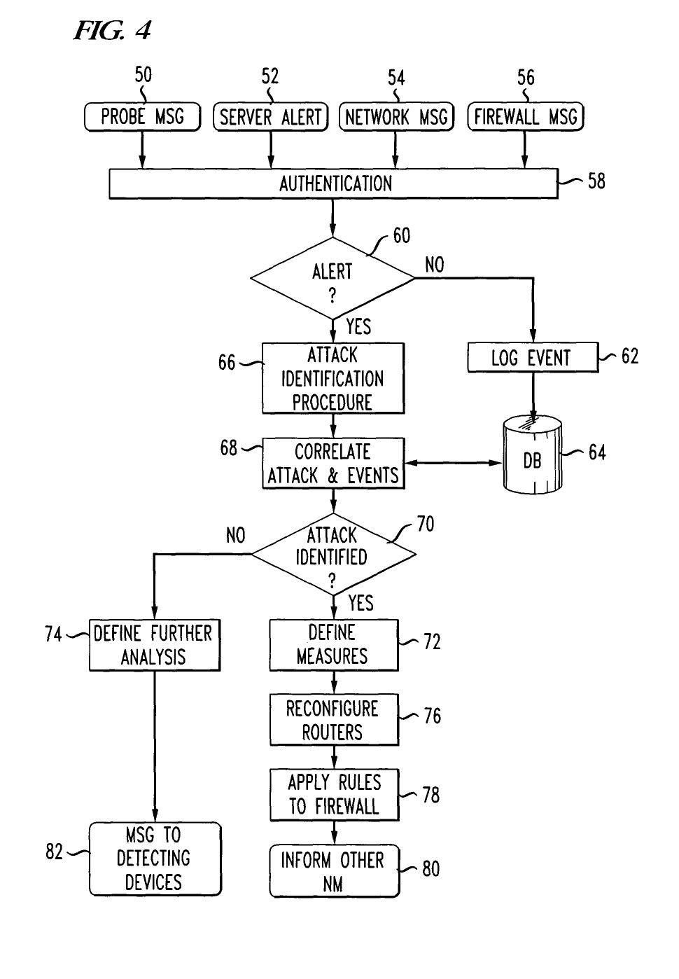

The process flow according to the invention is now described in reference to FIG. 4. The SNM is permanently waiting for a message coming from detecting devices. It can be a message 50 from security probe 32, an alert 52 from server 28, a network message 54 like a network congestion or overload on some interface, a firewall message 56 that has detected some intrusion.

The first step when a message is received is to perform authentication on step 58. the worst thing would be for the SNM 30 to be spoofed and attacked so it has to be protected to accept only messages from a known IP address with the right protocol. The SNM is located within the Intranet with no direct connection to the Internet, but this is not enough. A stronger authentication based on certificates is recommended.

After this preliminary step, either the message is an alert or not. This is checked in step 60. This information is included in the message itself. If it is just network statistics information or events on step 62, the information included in the message is appended to the SNM database 64.

If it is an alert, the SNM 66 proceeds to the identification of the style of the attack on step 66. The SNM knows all well-known attacks and tries to identify to which type this attack belongs. When a server comes under attack, it is important to recognize the style of attack. Sometimes it is a combination of styles. Four main types of attacks are most common. The first attack is Internet Control Message Protocol (ICMP) flooding. An ICMP ping on a server produces an echo response to confirm the server's presence. When enough pings are sent, the target server can do nothing but reply to the requests. The second is a “Smurf” attack. It appears to originate from the target server's own IP address or somewhere on its network. Targeted correctly, it can flood the network with pings and multiple responses. The third one is “User Datagram Protocol (UDP)” flooding. UDP diagnostic services generate characters that are echoed back from the receiving end to the host. This can swamp the network with useless data. The fourth one is Transmission Control Protocol (TCP) SYN message flooding. Multiple spoofed requests for TCP connections force the server to keep ports open, waiting for responses. These four types of attacks involve incoming traffic.

After this attack identification and classification, SNM can proceed on step 68 to a deeper analysis by getting back some events from DB 64 in order to correlate previous events with this attack in order to get a broader view of the attack, such as from which devices within the Intranet network it comes from and such as routers and firewalls in the path of attacks.

Then, it is determined whether the attack is well identified on step 70, that is if all gathered information is enough to understand the attack and how to fight against it and on which devices. Then, the process jumps from step 70 to step 72 to define the measures to be taken; or it is not clear enough and the SNM needs further information to understand the attack, the process jumps to step 74. There is a third option which is in fact a combination of both. The SNM may have defined some rules for some devices but needs complementary information to improve its knowledge and define additional rules. Therefore, a first set of actions are defined on step 72 to 80. But, in parallel, additional measurements and analysis are required via steps 74 and 82.

The action process starts on step 72 where measures are defined: it includes, for routers and firewalls, filtering up to discard, tunneling, classification. Then, routers (and possibly switches) are reconfigured on step 76, for example to reroute some traffic. The SNM may define new configurations but can ask another network management tool such as a centralized configuration tool to really apply the new router configuration (not shown). Similarly, new rules are applied to network devices such as firewalls for filtering and possibly data scanning on step 78 and finally other network management entities are warned on step 80.

If more information is required, the SNM defines on step 74 which devices are the more appropriate to perform this analysis, like firewalls at the boundary of the network or security probes the most often. The analysis to request is sent to the corresponding devices on step 82. The SNM normally does not perform analysis by itself, just to avoid being detected.

A possible request is, for example, to check whether source addresses are valid or not. This is normally performed by firewalls using pings. A good means is to assess the TTL found by analysis with the TTL used in DoS packets. If the source address is really on the network from which the packet is coming, then it has not been spoofed and the TTL of the packets should be very close to the TTL of a ping packet with a possible offset due to the default starting value of the TTL in the sending device which can take some basic values. If not, the IP address is spoofed. Of course, if the IP address doesn't answer to any type of ping (ICMP, UDP, TCP), there is a good probability that the source address is spoofed. Receiving packets with a spoofed source address means that it is certainly a DoS attack and strong measures can be taken using other parameters found on packets to identify them.

While this invention has been described in a preferred embodiment, other embodiments and variations can be effected by a person of ordinary skill in the art without departing from the scope of the invention.

1. Data transmission system including at least a data transmission network, at least a server, a plurality of users able to be connected to said server in order to get data from it and at least a user being able to initiate a denial of service attack, said system further including a security network manager and at least a detecting device for detecting abnormal operating conditions with respect to a system operation defined by predetermined parameters and for transmitting detection messages to said security network manager, said security network manager activating filtering actions upon receiving said detection messages: Data transmission system according to claim 1, including the Internet network to which are connected said users, and at least a first private network to which is connected said security network manager, and a local area network to which is connected said server. Data transmission system according to claim 2, wherein said Internet network and said private network are interconnected by a firewall, and said private network and said local area network are interconnected by a router; said server, said firewall and said router being detecting devices transmitting detection messages to said security network manager when they detect abnormal operating conditions. Data transmission system according to claim 3, further comprising a security probe connected to said local area network, said security probe being used as a detecting device for analyzing the traffic transmitted on said local area network and providing statistics to said security network manager. Data transmission system according to claim 4, wherein a server connected to said local area network includes its own firewall, the configuration of said firewall being within said security probe and being updated by said security network manager. Data transmission system according to claim 5, further including at least a second private network connected to said first private network by means of a router, all the traffic transmitted between said first private network and said second private network being re-routed to a specific firewall connected to said first private network. Process for protecting a data transmission system against a denial of service attack, said data transmission system comprising at least a data transmission network, at least a server, a plurality of users able to be connected to said server in order to get data from it and at least a user being able to initiate a denial of service attack, said process including the steps of detecting by detecting devices abnormal operating conditions of said data transmission system, transmitting a detection message from a detecting device having detected said abnormal operating conditions to a security network manager, analyzing the received detection message for determining whether there is a DoS attack and from which source this attack comes, and activating actions by said security network manager, said actions being applied to the devices of the system which are on the path between said source and the attacked device. Process according to claim 7, wherein said detection message is an alert message when said detecting device is a server. Process according to claim 7, wherein said detection message is a statistic message (LStat) when said detecting device is a security probe. Process according to claim 7, wherein said detection message is a statistics message (WStat) when said detecting device is a router. Process according to claim 8, further comprising the step of identification of the type of said attack when said detection message is an alert message, so that said security network manager is able to activate appropriate actions. Process according to claim 11, wherein said appropriate actions consist in re-configuring the routers of said data transmission network. Process according to claim 11, wherein said appropriate actions consist in transmitting new rules of filtering to the firewalls of said data transmission system. Process according to claim 9 or 10, wherein the information contained in said statistics messages is stored in a data base of said security network manager.
